(19) United States
(12) Patent Application Publication
(10) Pub. No.: US 2022/0401967 A1
(43) Pub. Date: Dec. 22, 2022

(54) CENTRIFUGE FOR AUTOMATIC LOADING

(71) Applicant: Andreas Hettich GmbH & Co., KG, Tuttingen (DE)

(72) Inventors: Matthias HORNEK, Tuttlingen (DE); Rainer PRILLA, Messstetten (DE); Klaus-Guenter EBERLE, Tuttlingen (DE)

(73) Assignee: Andreas Hettich GmbH & Co., KG, Tuttlingen (DE)

(21) Appl. No.: 17/775,723

(22) PCT Filed: Oct. 9, 2020
(86) PCT No.: PCT/EP2020/078392

§ 371 Date: May 10, 2022

(30) Foreign Application Priority Data
Nov. 12, 2019 (DE) 10 2019 130 524.1

(51) Int. Cl. B04B 11/04; B04B 5/04; B04B 7/06

(52) U.S. Cl. CPC B04B 11/04; B04B 5/0414; B04B 7/06; B04B 2011/046

(57) ABSTRACT

The invention relates to a centrifuge (10) for automatic loading, having a drive shaft (44), which is driven in a rotatable manner about a rotor axis (42), having a rotor (46), which is releasably coupled for conjoint rotation to the drive shaft (44) and has mounts for containers for media to be centrifuged, having a housing (12) with lateral outer walls (14, 16, 18, 20) delimiting the centrifuge (10) and with a ceiling (22), wherein at least one outer wall (14) has a sideways directed side opening (28) for loading the rotor (46) as required, and having a safety vessel (50) with at least one partially enclosing protective wall (34), which is adapted at least to the shape of the adjacent outer wall (14) with side opening (28) such that said protective wall closes off the side opening (28).

This patent application is the national phase entry of PCT/EP2020/078392, international application filing date Oct. 9, 2020, which claims the benefit and priority of and to German patent application no. 10 2019 130 524.1, filed Nov. 12, 2019.

PCT/EP2020/078392, international application filing date Oct. 9, 2020 and German patent application no. 10 2019 130 524.1, filed Nov. 12, 2019 are incorporated herein by reference hereto in their entireties.

### BACKGROUND OF THE INVENTION

The invention relates to a centrifuge for automatic loading.

In automated systems, centrifuges are used which have loading openings that open and close automatically. This allows them to be loaded and unloaded automatically using robots. In particular in applications where microplates are used as carriers, horizontal or lateral feeding is common because so-called SCARA robots only operate in the horizontal direction.

A generic centrifuge for automatic loading is disclosed in DE 10 2013 104 141 A1. This centrifuge includes a drive shaft that is driven in a rotatable manner about a rotor axis. A rotor is arranged on the drive shaft, which rotor is releasably coupled to the drive shaft for conjoint rotation, said rotor having mounts for containers for media to be centrifuged. In addition, the centrifuge includes a housing with outer side walls delimiting the centrifuge and with a ceiling. One outer wall has an opening that faces sideways for loading the rotor as necessary. Furthermore, a safety vessel is provided in the housing into which the drive shaft projects concentrically. The safety vessel completely surrounds the rotor with regard to and along the rotor axis. The safety vessel is surrounded by a protective wall, which is adapted to the shape of the adjacent outer wall of the housing and which, in a closed position, closes the outer wall in the area of the side opening. In this case, the safety vessel and the protective wall surrounding it are firmly interconnected and form a safety unit arranged in the housing. The safety unit cooperates with an adjustment mechanism which enables the safety unit to be moved relative to the housing such that the protective wall opens and closes the side opening of the outer wall of the housing. The protective wall can thus be moved out of a closing position into an opening position, and vice versa.

Other types of robot systems are now being used more and more which require the centrifuge to have larger opening cross-sections or to be capable of being loaded in the vertical direction. However, the centrifuge still needs to have the feature of completely and safely enclosing the rotor chamber so that in the case of a crash, the safety unit will ensure that the parts moved by the damaged rotor will be retained completely inside the centrifuge.

Disclosed in WO 2013/003692 A1 is a centrifuge having a side opening and a ceiling opening, which together form the loading opening. However, the loading opening can only be rotatably closed by a hatch which can be moved by a rotary mechanism. The hatch has at least the shape of the loading opening and adjoins a ceiling of the housing and a side wall of the safety vessel, offset by the wall thickness of the ceiling and the side wall. The shortcomings of this design are that, except for the housing, there is no protective wall surrounding the safety vessel and that the hatch is inflexible in design as regards its operation. Another disadvantage is that the safety vessel has a hatch opening at its periphery, i.e. the most highly stressed area in the case of a crash that will be hit by the broken rotor parts, which significantly reduces the stability of the safety vessel. As a result, the required safety standard cannot be achieved. The centrifuge is only designed for low rotational speeds of the rotor. Another shortcoming of this opening is that there will be air turbulence in the gap between the hatch and the safety vessel, resulting in an increased noise level during operation.

Disclosed in U.S. Pat. No. 9,446,417 B2 is another centrifuge having a side opening for loading.

### SUMMARY OF THE INVENTION

It is the object of the invention to improve on a centrifuge in such a way that flexible opening of the loading opening is ensured, in particular in centrifuges with high rotational speeds, while avoiding the above mentioned disadvantages, thus ensuring high stability of, and a high safety standard for, the centrifuge.

This object is accomplished by the characterizing features of claim 1 in conjunction with the features of its preamble.

The dependent claims relate to advantageous further embodiments of the invention.

The invention is based on the realization that providing a ceiling opening next to a side opening in connection with a two-part, wall-shaped closing element for closing the loading opening will increase the design options for safe centrifuges, especially in the area of the weak point of the centrifuge, i.e. the loading opening.

The invention therefore provides for the side opening to extend up to the ceiling. Adjacent to this, a ceiling opening is provided in the ceiling, resulting in a loading opening formed by a side opening and a ceiling opening, with the ceiling opening being adapted to be opened and closed via a further closing wall by means of a second adjustment mechanism. This then also allows the use of robots that require a larger loading opening and, in particular, also require space diagonally upwards for the loading and unloading process, without compromising the safety of the centrifuge.

Preferably, the first and second closing mechanisms are coupled to one another so that the respective opening and closing movements of the protective wall and of the closure wall will be coordinated.

Such coupling can be of an electrical or a mechanical nature. In the case of a mechanical coupling, the first and second adjustment mechanisms are coupled with each other in such a way that during the opening movement, the protective wall will open first and then, with some time delay, will the dosing wall, and during the dosing movement, the dosing wall will close first and then, with some time delay, will the protective wall. This has the advantage that additional structural measures for increased stability in the area of the loading opening in the closed position will be possible.

Preferably, the dosing wall is mounted such that it can be displaced in a translational movement, in particular at right angles to the rotor axis. This has the advantage that less space will be required for moving the closing wall.

For increased stability of the dosing wall, the latter has been designed such that it extends into the side opening in the closed position, in particular thereby forming a plane with the protective wall on the outside.

Stability and safety in the closed position in the area of the loading opening are also increased by the fact that in the closed position, parts of the dosing and protective walls will overlap, for which purpose the protective wall has a shoulder in which certain areas of the dosing wall engage.

In order to provide cooing during operation, an air intake opening is provided in the closing wall and an air intake opening is provided in the ceiling of the housing, which openings are aligned with one another in the closed position. During operation, air thus first enters the rotor chamber through the air intake opening in the ceiling of the housing via the air intake opening in the closing wall.

In one embodiment of the invention, a spring is provided which acts on the closing wall in the direction of the closed position so that the dosing wall is opened against the spring force of the spring. This ensures that the closing position is always retained during operation and that unintentional opening of the loading opening is avoided.

Preferably, the dosing wall is formed of sheet metal. This allows for a compact and inexpensive design, which is also deformable enough to absorb the energy of the impacting parts in the event of an accident. The safety vessel can also be made of a deep-drawn sheet metal part that will convert the kinetic energy of parts being flung away into deformation energy.

The protective wall can be part of a protective housing which surrounds the safety vessel. This allows for a small design of the centrifuge and further increases safety.

It is of great advantage with regard to safety in the event of a crash if, according to one embodiment of the invention, the protective housing is completely closed over its height in the horizontal direction. In other words, it has no openings or recesses on its periphery for loading and unloading. Therefore, the most highly stressed area of a centrifuge in the case of a crash, i.e. the area that will be hit by the fragments of a broken rotor, is not weakened by a hatch opening.

Preferably, the protective housing is made of sheet metal, which has good energy-absorbing properties in the event of a crash. In a simple manner, the kinetic energy will thus be converted into deformation energy. As an alternative or in addition, the safety vessel can also be formed from sheet metal.

According to an advantageous further embodiment of the invention, the safety vessel is rotationally symmetrical. The safety vessel can be closed over its height in the radial direction. As a result, the safety vessel has a high strength that is not compromised by any recesses or openings.

In order to further increase safety, the closing wall is dimensioned such that, in the closed position, the dosing wall completely covers the safety vessel and/or the closing wall completely covers the protective housing. From there, towards the top, both the closing wall and the ceiling of the housing are provided, which will shield the interior of the rotor and serve as energy absorbers for the parts being flung away from the rotor in the case of an accident.

In the closed position, the safety vessel and/or the protective housing will rest sealingly against the dosing wall. This will thus prevent the flow in the rotor chamber from being affected by possible leakage.

Preferably, for this purpose, the safety vessel and/or the protective housing is/are provided with a seal on their side facing the dosing wall in the closed position.

Increased safety can also be achieved by the closing wall having respective laterally downwardly extending support walls which are coupled to the second adjustment mechanism. The support walls are preferably integrally formed with the dosing wall, and made of the same material as the latter.

In one embodiment of the invention, the first adjustment mechanism has at least one push rod which engages laterally with the safety unit in an articulated manner and is coupled in an articulated manner to a horizontally displaceable driven sliding carriage at the bottom of the centrifuge. This makes it possible to dispose the mass required for the adjustment mechanism close to the bottom.

Preferably, the second adjustment mechanism has at least one driver in the area of the sliding carriage, which will operatively couple when the sliding carriage has been displaced a predetermined distance. Above all, the predetermined distance depends on the height of the part of the closing wall that projects into the side opening in the closed position.

The safety vessel may have a central recess that enables the opening and dosing movement relative to the drive shaft. A safety cover can be provided which surrounds the drive shaft and covers the central recess in the closed position and which, together with the safety vessel and the dosing wall, completely delimits a rotor chamber with the rotor, except for the passage for the drive shaft.

Additional advantages, features and possible applications of the present invention will be apparent from the description which follows, in which reference is made to the embodiments illustrated in the drawings.

Throughout the description, the claims and the drawing, those terms and associated reference signs are used as are listed in the List of Reference Signs below.

### BRIEF DESCRIPTION OF THE DRAWINGS

In the drawings,

FIG. 1 is a perspective view of a centrifuge according to the invention, as seen at an angle from above, with its loading opening nearly open;

FIG. 2 is a perspective view of the centrifuge of FIG. 1, with its loading opening closed;

FIG. 3 is a longitudinal sectional view through the centrifuge of FIG. 1, with its loading opening closed;

FIG. 4 is a perspective view of the centrifuge of FIG. 1, with its loading opening open;

FIG. 5 is a lateral view of the centrifuge of FIG. 1 without the housing, drive and rotor, and with the safety unit and the dosing wall in the closed position;

FIG. 6 is a lateral view of FIG. 5 of a first intermediate position as the safety unit and the dosing wall move out of the closed position into the open position;

FIG. 7 is a lateral view of FIG. 6 in a second intermediate position as the safety unit and the dosing wall move out of the closed position into the open position:

FIG. 8 is a lateral view of FIG. 7 in the open position of the safety unit and the closing wall;

FIG. 9 is a perspective view of a sliding carriage of the first and second adjustment mechanisms in the closed position:

FIG. 10 is a lateral view of FIG. 9 of a first intermediate position as the safety unit and the dosing wall move out of the closed position into the open position;

FIG. 11 is a perspective view of FIG. 9 of a second intermediate position as the safety unit and the closing wall move out of the closed position into the open position, and

FIG. 12 is a lateral view of FIG. 9 illustrating the safety unit and the closing wall in the open position.

### DESCRIPTION OF THE INVENTION

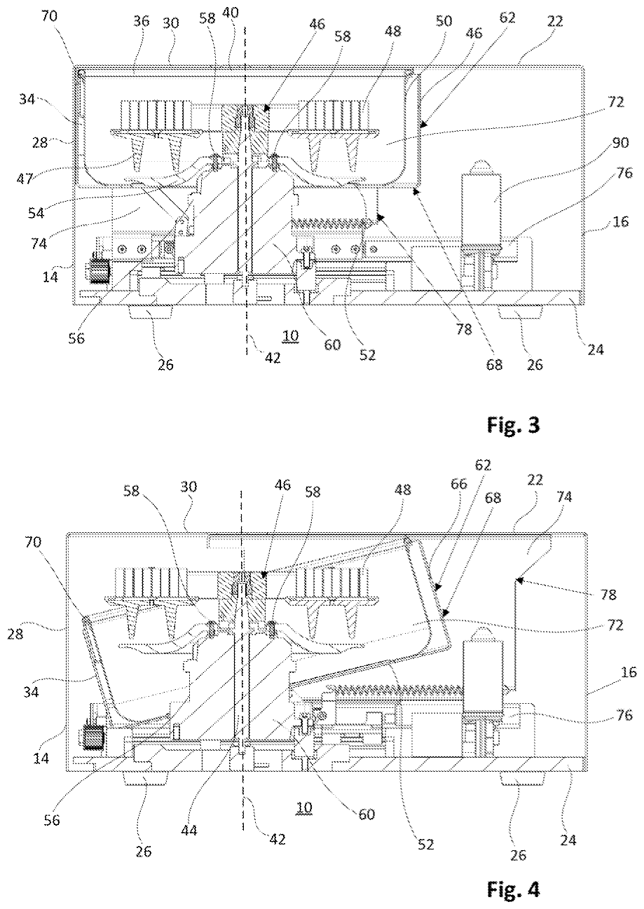

Illustrated in the Figures is an embodiment of a centrifuge 10 according to the invention for automatic loading and unloading. The centrifuge 10 comprises a housing 12 having a front wall 14, a rear wall 16, a left side wall 18, and a right side wall 20. The top of the housing 12 is closed by a ceiling 22 and the bottom of the housing 12 is firmly connected to a base plate 24, see FIG. 3 and FIG. 4. Each corner region of the base plate 24 is provided with a foot 26, i.e. there is a total of four feet 26.

The housing 12 has contiguous rectangular recesses 28 and 30 in its central region between the end wall 14 and the ceiling 22, respectively, which together form a loading and unloading opening 32 of the centrifuge 10.

The loading and unloading opening 32 is configured such that it can be closed off. More specifically, the recess 28 in the end wall 14 is closed by a protective wall 34 and the recess 30 is closed by a dosing wall 36.

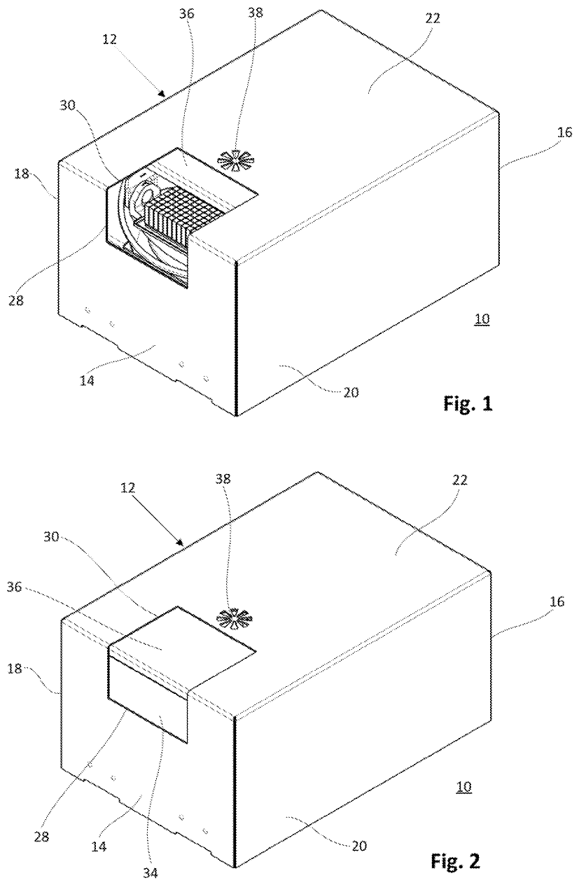

Adjacent to the recess 30 in the ceiling 22 there is an air intake opening 38, which is aligned with another air intake opening 40 in the closing wall 36 when the loading and unloading opening 32 is closed, see FIG. 2.

As can be seen in particular from FIGS. 3 and 4, the centrifuge 10 has a drive shaft 44 that is mounted so as to be rotatable about a rotor axis 42. A rotor 46 is coupled to the drive shaft 44 for co-rotation therewith, but in a releasable way. The rotor 46 is provided with hangers 47, on which there are plates 48 (e. g. microtiter plates, deep well plates) having a large number of wells filled with the liquids to be centrifuged. These filled plates are introduced int the centrifuge and removed therefrom by means of a robot.

A safety vessel 50 is rotationally symmetrical and surrounds the rotor 46 in a radial direction over its entire height and beyond its top and bottom. A circular recess 52 is provided in a bottom of the safety vessel 50, which recess is dimensioned such that tilting is possible, as will be described in more detail below. This recess 52 is closed by a rotationally symmetrical cover 54 when the safety vessel 50 is in the operating state of the centrifuge 10, see FIG. 3.

The cover 54 is coaxially connected to a drive housing 56 via screws 58. In the drive housing 56, the drive shaft 44 is rotatably mounted and driven by a drive motor 60. The drive housing 56 is firmly secured to the base plate 24, and via it, so is the cover 54. The cover 54 surrounds the drive shaft 44 without contacting it. Above the cover 54, the rotor 46 is mounted on the drive shaft 44. In operation, the drive shaft 44 with the rotor 46 mounted thereon rotates relative to the cover and the drive housing 56.

The safety vessel 50 is surrounded by a protective housing 62 which is rectangular in shape. The protective housing 62 is provided with an end face, which is formed by the protective wall 34. In addition, left and right side walls 64 are provided, as well as a rear wall 66. The protective housing 62 together with the safety vessel 50 forms a safety unit 68. On the upper edge of the safety vessel 50, a circumferential seal 70 is provided.

The seal 70 is in sealing engagement with the closing wall 36 when the safety unit 68 is in the operating position of the centrifuge 10, see FIG. 3. In this position, a closed rotor interior 72 is formed that is delimited by the dosing wall 36, the safety vessel 50 and the cover 54. The drive shaft 44 with the rotor 46 engages in the rotor interior 72.

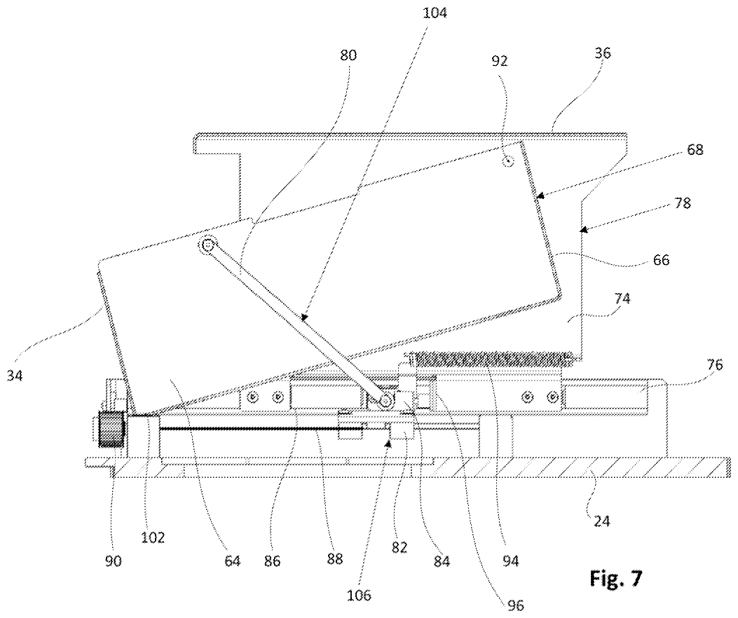

Each side of the closing wall 36 is provided with a respective side wall 74 extending in the direction of the base plate 24. In its lower portion, the side wall 74 is each inserted into a guide rail 76 which runs parallel to the base plate 24 and in the longitudinal direction of the centrifuge 10 and is bolted to it, see FIGS. 7 to 12. The closing wall 36 and the side wall 74 thus form an additional housing unit 78 which can be displaced along the guide rail. More specifically, the dosing wall 36 is arranged directly below the top 22 of the housing 12.

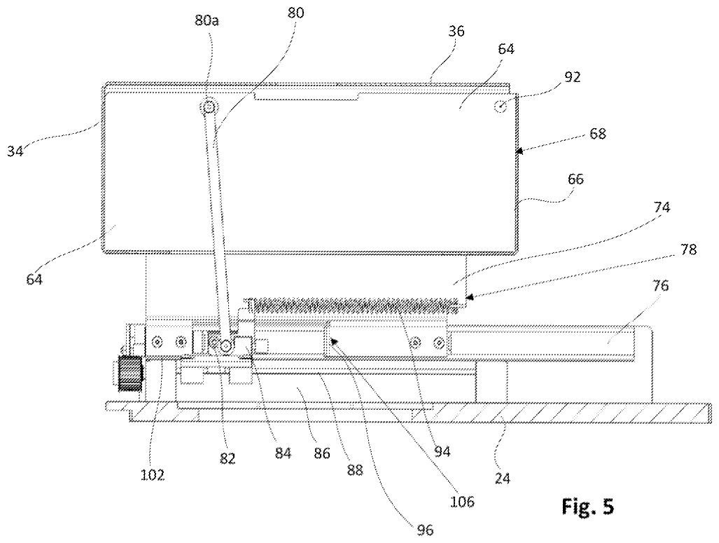

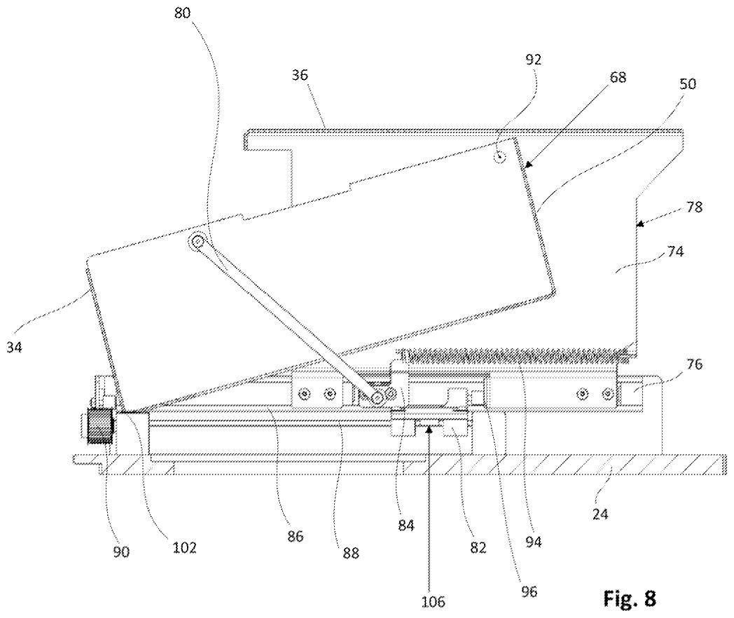

FIGS. 5 to 8 show in detail how the safety unit 68 and the additional housing unit 78 with the closing wall 36 are moved so as to transfer the centrifuge 10 from an operating position thereof, see FIG. 2, FIG. 3 and FIG. 5, to a loading and unloading position thereof, see FIG. 1. FIG. 4 and FIG. 8. In order to initiate the opening movement of the safety unit 68, on the inside of each side wall 64 of the protective housing 62, a push rod 80 is articulated at its free end in the upper region of the ide wall 64 via a joint 80a. The push rod 80 extends to the guide rail 76, where it engages in an articulated manner in a sliding carriage 82 that is displaceably mounted in the guide rail 76.

The sliding carriage 82 in turn engages in another sliding carriage 84, which is guided in another guide rail 86. The additional guide rail 86 extends in parallel to guide rail 76. The sliding carriage 82 and the additional siding carriage 84 are coupled to one another, as will be described in detail below.

The additional sliding carriage 84 is connected to a threaded spindle 88. The threaded spindle 88 is in turn connected to a drive 90. The drive 90 drives the threaded spindle 88, causing it to rotate. This results in the additional carriage 84 engaging in the threaded spindle 88 and its thread to be moved translationally along the additional guide rail 86.

On the side remote from the joint 80a on the inside of the side wall 64, in the operating position approximately at the same height, a hinge 92 is provided in each case, by means of which the safety unit 68 is mounted pivotably about a fixed axis. The hinge 92 is connected to the base plate 24 via support arms not shown here for greater clarity.

The first sliding carriage 82 is connected to a coil spring 94, which in turn engages the side wall 74 of the additional housing unit 78 on the side remote from the first sliding carriage 82. The closing wall 36 is thus held in the direction of the operating position by the cod spring 94, i.e. it is acted upon by the force of the coil spring 94.

The construction consisting of sliding carriages 82, 84 and guide rails 76, 86 and threaded spindle 88 is present on both side walls 74 of the additional housing unit 78. Only the drive 90 is present on one side only, and it is connected to the additional threaded spindle 88 via a toothed belt. As a result, both threaded spindles 88 are driven synchronously, thus moving the sliding carriages 82, 84 on both side walls 74.

As can be seen in particular from FIGS. 3 and 4 and FIGS. 6 to 8, the free end of the closing wall 36 is formed in such a way that it extends partially into the recess 28. In addition, the associated area of the protective wall 34 is provided with a shoulder, resulting in the protective wall 34 and the closing wall 36 to overlap in the operating position, see FIG. 3 and FIG. 5.

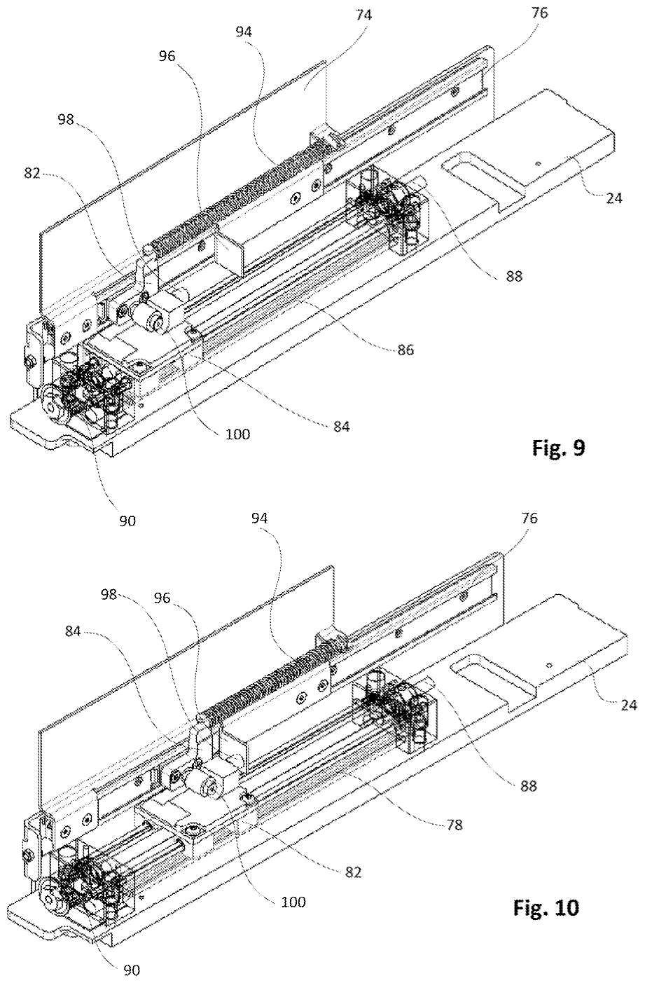

The views of FIGS. 9 to 12 show the first guide rail 76 and the second guide rail 86 in more detail. Each side wall 74 engages in the first guide rail 76. With respect to its base, the first guide rail 76 is oriented parallel to the side wall 74. In the area of the guide rail 76, the side wall 74 is provided with a driver 96. The driver 96 is arranged relative to the sliding carriages 82 and 84 in such a way that a stop 98 associated with the driver 96 and connected to the second sliding carriage 84 will not engage the driver 96 until after the sliding carriage 84 has traveled a predetermined distance.

The second guide rail 86 consists essentially of two guide rods on which the second sliding carriage 84 is arranged. The base of the second guide rail 86 is parallel to the base plate 24.

The first sliding carriage 82 engages in the first guide rail 76. The second sliding carriage 84 has an L-shaped support structure, the upper part of which is connected to one end of the coil spring 94. A joint 100 for the push rod 80 protrudes vertically from the support structure. The rear side of the stop 98 is adapted to the shape of the joint 100.

FIG. 5 and FIG. 9 show the situation of the centrifuge 10 in its operating position. The closing wall 36 closes off the recess 30 in the ceiling 22, and the protective wall 34 closes off the recess 28 in the end wall 14. The loading and unloading opening 32 is closed. The centrifuge 10 is ready for treating the introduced media in the sample containers in the rotor 46 by centrifugation.

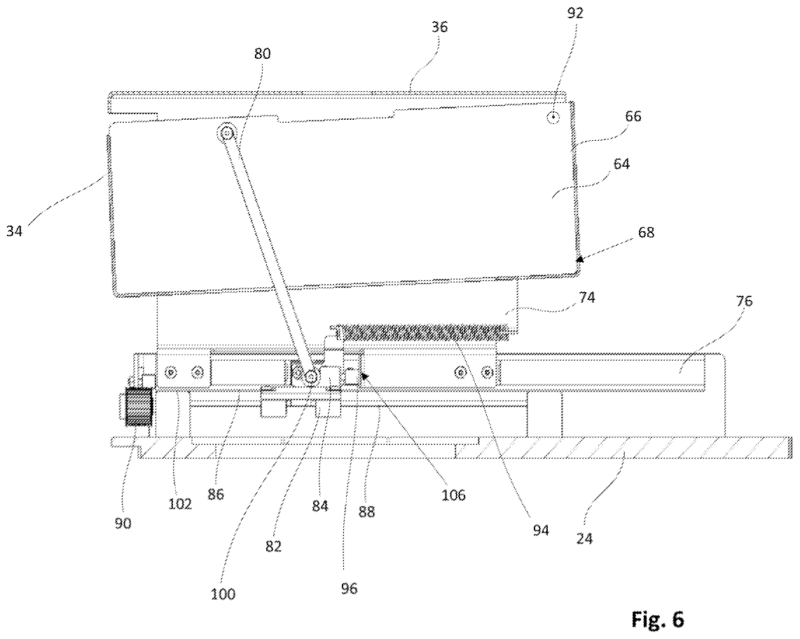

Once the centrifuging process has been completed and the centrifuge 10 is to be unloaded and/or loaded, the loading and unloading opening 32 needs to be opened. For this purpose, the protective wall 34 and thus the safety unit 68 are first tilted downward by moving the sliding carriage 82 with the siding carriage 84 to the right, by means of the drive 90. This causes the push rod 80 to pivot and the safety unit 68 to fold around the stationary hinge 92. This is required in order to cause the overlapping parts of the closing wall 36 and the protective wall 34 to move apart first. This first intermediate position during the movement out of the operating position into a loading and unloading position is shown in FIG. 6 and FIG. 10. In this case, the sliding carriage 82 is moved with the additional sliding carriage 84 until the stop 98 bears against the driver 96. The protective wall 34 and the closing wall 36 no longer overlap.

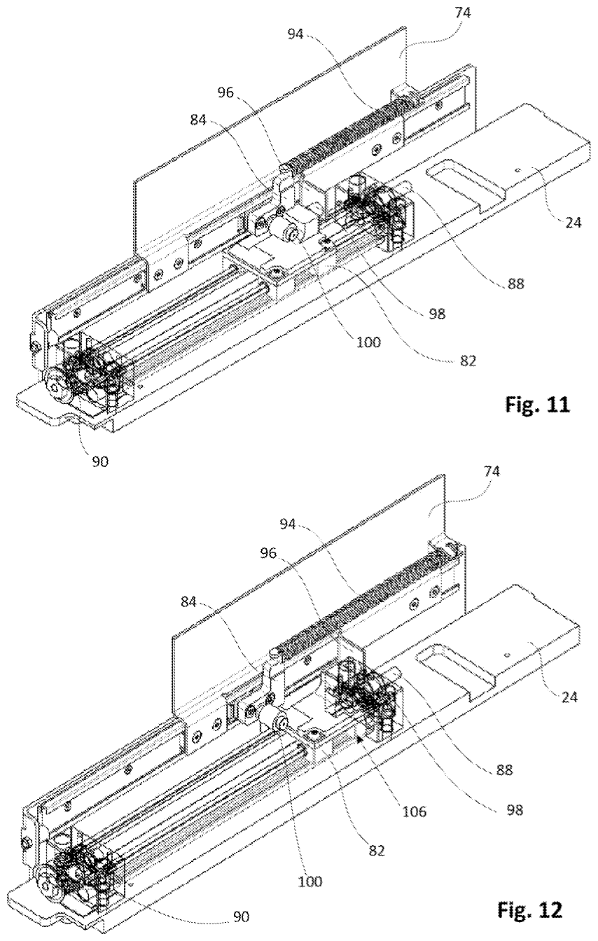

In the next step, the safety unit 68 pivots with the protective wall 34 about the hinge 92 until the safety unit 68 rests with its front lower end and the lower end of the protective wall 34 on a stationary support 102. The support 102 is firmly connected to the base plate. The pivoting of the safety unit 68 is initiated by the movement of the siding carriage 82 with the sliding carriage 84. In this process, the push rod swivels about the joint 100. At the same time, the additional housing unit 78 moves with the siding carriages 82 and 84 until the front end of the safety unit rests on the support 102. This situation is shown in FIG. 1, FIG. 7 and FIG. 11.

In the next step, the sliding carriage 84 moves further and the sliding carriage 82 stops, since further swiveling is no longer possible. The sliding carriage 82 with the push rod 80 and the safety unit 68 is held by the hinge 92. Driven by the drive 90, the slide 84 continues to move to the loading and unloading position, and so does the additional housing unit 78 consisting of the closing wall 36 and the two side walls 74. This situation is shown in FIG. 4. FIG. 8 and FIG. 12.

Sliding carriage 84, driven by the threaded spindle and the motor, drives the first sliding carriage (driver function on the left) and also drives the closing wall, with some time delay (driver function on the right).

Driver function on the left: Lower vessel from closed to open in end position

Driver function on the right: Move closing wall

Procedure:

Phase 1: Driving first bearing 82->tilting of safety unit 68, closing wall 36 stationary

Phase 2: Driving first bearing 82->tilting of safety unit 68 and driving losing wall 36

Phase 3: First bearing 82 stops, safety unit has reached and position, closing wall 36 is moved further to end position.

The movements of the protective wall 34 and the closing wall 36 are thus coordinated and are coupled with one another. During the opening movement, the protective wall 34 opens first and then does the dosing wall 36, after some time delay. During the closing movement, the dosing wall 36 closes first and then does the protective wall 34, after some time delay.

During the opening movement, the closing wall 36 moves translationally parallel to the guide rails 76 and thus at right angles to the rotor axis 42.

The protective housing 62 and the safety vessel 50 and thus the protective wall 34, but also the dosing wall 36, are made of sheet metal. More specifically, both the protective housing 62 and the safety vessel 50, over its height in the horizontal direction, are of a closed design.

In the operating/closing position, the closing wall 36 completely covers the safety vessel 50.

### LIST OF REFERENCE SIGNS

10 Centrifuge
12 Housing
14 End wall
16 Rear wall
18 Side wall, left
20 Side wall, right
22 Ceiling
24 Base plate
26 Foot
28 Recess, end wall
30 Recess, top
32 Loading and unloading opening of centrifuge 10
34 Protective wall for dosing recess 28
36 Closing wall for closing recess 30
38 Air intake opening in top 22
40 Additional air intake opening in dosing wall 36
42 Rotor axis
44 Drive shaft
46 Rotor
47 Hanger of rotor 46
48 Plates with cavities
50 Safety vessel
52 Recess in safety vessel
54 Cover of recess 52
56 Drive housing
58 Screw
60 Drive motor
62 Protective housing
64 Side wall of protective housing 62
66 Rear wall
68 Safety unit consisting of safety vessel 50 and protective housing 62
70 Seal of the safety vessel 50
72 Rotor interior
74 Side wall connected to closing wall 36
76 Guide rails
78 Additional housing unit consisting of dosing wall 36 and two side walls 74
80 Push rod
80a Joint of push rod 80
82 First sliding carriage
84 Additional second sliding carriage
86 Additional guide rail
88 Threaded spindle
90 Drive
92 Hinge
94 Col spring
96 Driver
98 Stop
100 Joint on first sliding carriage 82 for push rod 80
102 Support

1-25. (canceled)

26. A centrifuge (10) for automatic loading, comprising
a drive shaft (44), which is driven in a rotatable manner about a rotor axis (42),
a rotor (46), which is releasably coupled for conjoint rotation to the drive shaft (44), and has mounts for containers for media to be centrifuged,
a housing (12) with lateral outer walls (14, 16, 18, 20) delimiting the centrifuge (10) and with a ceiling (22), wherein at least one outer wall (14) has a side opening (28) facing sideways for loading the rotor (46) as required,
a safety vessel (50) into which the drive shaft (44) projects and which encloses the rotor (46),
a protective wall (34), which surrounds the safety vessel (50) at least partially, which protective wall is adapted at least to the shape of the adjacent outer wall (14) with side opening (28) such that it closes off the side opening (28),
wherein the safety vessel (50) and the protective wall (34) form a firmly interconnected safety unit (68), which is in operative connection with an adjustment mechanism (104), by means of which the safety unit (68) can be moved such that the protective wall (34) opens and closes the side opening and therefore the protective wall can be moved out of a closing position into an opening position, and vice versa, characterized in that the side opening (28) extends to the ceiling (22) and is adjoined by a ceiling opening (30) in the ceiling (22), so as to create a loading and unloading opening (32) formed from the side opening (28) and ceiling opening (30), wherein a second adjustment mechanism (106) can be used to open and close the ceiling opening (30) by means of a further closing wall (36).

27. The centrifuge of claim 26, characterized in that the first and second adjustment mechanisms are mechanically coupled to one another, resulting in the opening movement and the closing movement of the protective wall (34) and of the closing wall (36) to be coordinated.

28. The centrifuge of claim 27, characterized in that the first and second adjustment mechanisms (104, 106) are mechanically coupled to one another.

29. The centrifuge of claim 28, characterized in that the first and second adjustment mechanisms (104, 106) are coupled to one another in such a way that, during the opening movement, the protective wall (34) will be the first to open, with the closing wall (36) opening with some time delay thereafter, and, during the closing movement, the closing wall (36) will be the first to close, with the protective wall (34) closing with some time delay thereafter.

30. The centrifuge of claim 1, characterized in that the closing wall (36) is mounted so that it can be displaced translationally, in particular at right angles to the rotor axis (42).

31. The centrifuge of claim 1, characterized in that the closing wall (36) is designed in such a way that it extends into the side opening (28) in the closed posi-tion, in particular thereby forming a plane with the protective wall (34) on the outside of the cen-trifuge (10).

32. The centrifuge of claim 31, characterized in that, in the closing position, the closing wall (36) and the protective wall (34) overlap in certain areas, and for this purpose the protective wall (34) has a shoulder in which part of the closing wall (36) engages.

33. The centrifuge of claim 1, characterized in that an air in-take opening (40) in the closing wall (36) and an air intake opening (38) in the ceiling (22) of the housing (12) are provided, which openings are aligned with one another in the closed position.

34. The centrifuge of claim 1, characterized in that a spring (94) is provided which acts on the closing wall (36) in the direction of the closed position, so that the closing wall (36) is opened against the force of the spring (94).

35. The centrifuge of claim 1, characterized in that the closing wall (36) is made of sheet metal.

36. The centrifuge of claim 1, characterized in that the protective wall (34) is part of a protective housing (62) that completely encloses the safety vessel (50) in the circumferential direction.

37. The centrifuge of claim 36, characterized in that the protective housing (62) is completely closed in the horizontal direction over its height.

38. The centrifuge of claim 36, characterized in that the protective housing (62) is made of sheet metal.

39. The centrifuge of claim 1, characterized in that the safety vessel (50) is made of sheet metal.

40. The centrifuge of claim 1, characterized in that the safety vessel (50) is rotationally symmetrical, in particular is of a closed design over its height in the radial direction.

41. The centrifuge of claim 1, characterized in that the closing wall (36) is dimensioned such that, in the closing position, the closing wall (36) will completely cover the safety vessel (50).

42. The centrifuge of claim 1, characterized in that the closing wall (36) is dimensioned such that, in the closed position, the closing wall (36) completely covers the protective housing (62).

43. The centrifuge of claim 1, characterized in that, in the closed position, the safety vessel (50) and/or the protective housing (62) bear(s) sealingly against the closing wall (36).

44. The centrifuge of claim 43, characterized in that the safety vessel (50) and/or the protective housing (62) has/have a seal (70) on its respective side facing the closing wall (36) in the closed position.

45. The centrifuge of claim 1, characterized in that the closing wall (36) has support walls (74) that extend laterally downwards and are coupled to the second adjustment mechanism (106).

46. The centrifuge of claim 1, characterized in that the first adjustment mechanism (104) has at least one push rod (80) which engages the side of the safe-ty unit (68) in an articulated manner and which is coupled in an articulated manner to a driven horizontally displaceable sliding carriage (82, 84) at the bottom of the centrifuge (10).

47. The centrifuge of claim 46, characterized in that the second adjustment mechanism (104) comprises at least one driver (96) in the area of the sliding carriage (82, 84), which operatively couples when the sliding carriage (82, 84) has been displaced over a predetermined distance.

48. The centrifuge of claim 47, characterized in that the predetermined distance depends on the height of the portion of the closing wall (36) which projects into the lateral opening (28) in the closing position.

49. The centrifuge of claim 1, characterized in that the safety vessel (50) has a central recess (52) which allows the opening and closing movement of the safety unit (68) relative to the drive shaft (44).

50. The centrifuge of claim 49, characterized in that a safety cover (54) is provided which surrounds the drive shaft (44) and covers the central recess (52) in the closed position and which, together with the safety vessel (50) and the closing wall (36), completely delimits a rotor chamber (72) with the rotor (46), except for the passage for the drive shaft (44).
